(19) United States
(12) Patent Application Publication
(10) Pub. No.: US 2007/0128572 A1
(43) Pub. Date: Jun. 7, 2007

(54) Process for making an orthodontic band

(76) Inventor: Daniel Herman, Sheboygan, WI (US)

Correspondence Address: Philip G. Meyers;Philip G. Meyers Law Office, Suite 300, 1009 Long Prairie Road, Flower Mound, TX, 75022, US

(21) Appl. No.: 11/293,064

(22) Filed: Dec. 2, 2005

(51) Int. Cl. A61C 3/00

(52) U.S. Cl. 433/23

(57) ABSTRACT

A method for making an orthodontic band configured for mounting on a human molar includes the steps of feeding a strip of metal to a die press, cutting a flat blank from the metal strip, die pressing the flat metal blank into cup having a sidewall, an open bottom and a top wall, the cup having a flange extending outwardly from the open bottom, removing the outwardly extending flange from the cup and then die punching a hole through the top wall to form an inwardly directed annular flange.

### TECHNICAL FIELD

The present invention relates to orthodontic appliances, and in particular, to a process for making orthodontic crowns.

### BACKGROUND OF THE INVENTION

An orthodontic crown is a cup-shaped stamped stainless steel piece used to produce a band that is applied to a molar for anchoring an orthodontic appliance such as a Herbst appliance. A Herbst appliance is designed to effect an orthopedic change of the mandible by forcing the jaw to function in an anterior position to stimulate correction of Class II malocclusions. Such devices require a firm anchor and are usually secured to a molar and/or a bicuspid with an orthodontic band.

Orthodontic bands serve an important function during the orthodontic treating of a patient to correct malocclusions. Such bands may be applied to all of the teeth or only to anchor teeth in accordance with the particular technique preferred by the orthodontist. Importantly, the bands reduce tendencies for carious attack on the tooth due to their circumferential protection of the enamel. Additionally, they are important in that they allow secure attachment of various brackets or tubes to the teeth that facilitate orthodontic biomechanics. Finally, the bands serve to more evenly distribute a tooth-moving force over the area of an individual tooth.

Conventional orthodontic bands are generally tubular in shape and do not extend over the top of the tooth. Recently, however, there has emerged a desire for modified orthodontic bands having an inwardly directed flange at the top of the band referred to as an occlusal rollover. Orthodontic labs have custom-made crowns into bands with an occlusal rollover by taking a can-shaped crown closed at one end and drilling out the center using a Dremel tool or a laser. The flange is then pressed-fit into conformity with the top of the molar at the time of installation.

When the modified band is placed on a tooth such as a molar, the flange is pressed-fit into conformity with the top of the molar. The advantages of the modified band include greater strength, better oral hygiene reducing the risk of caries, lower risk of breakage, reduced cost and chair time and improved patient comfort. Additionally, it is easier to remove the appliance at the end of treatment than with a conventional can-shaped crown.

A primary anticipated use for the modified band is molar distalization using a Herbst appliance. Typically, Herbst appliances include a hollow tube and a rod which is telescopically received in the tube. The tube is connected to a maxillary arch expander and the rod is connected to the mandibular arch expander. Generally, the tube and rod are connected to a band or stainless steel crown by a pivoting connection. A second anticipated use for the modified band is in connection with rapid palatal expansion using an expander. The present invention concerns a method for mass production of crowns having an occlusal rollover suitable for the foregoing uses, among others.

### SUMMARY OF THE INVENTION

In accordance with the invention, a method for making an orthodontic band configured for mounting on a human tooth includes the steps of die pressing a metal blank into an orthodontic crown having a cylindrical sidewall, an open bottom and a round top wall, and then die forming the crown through the top wall using a die having a diameter less than that of the cylindrical sidewall, thereby removing a round central portion of the top wall to form an inwardly directed annular flange which can be press-fitted into conformity with a tooth surface when the band is mounted on the tooth, typically a molar or bicuspid. fit In another aspect, the method includes the step of etching a side of the metal prior to cutting the circular, flat blank from the strip.

### BRIEF DESCRIPTION OF THE DRAWINGS

In the accompanying drawings:

FIG. 1 is a series of bottom views of a metal blank at various stages as it is formed into a orthodontic crown in accordance with a method of the invention;

FIG. 2 is a series of cross sectional views of the metal blank of FIG. 1 at corresponding stages; and

FIG. 3 is a schematic representation of a set of teeth with an orthodontic band made in accordance with the invention installed on a molar thereof.

### DETAILED DESCRIPTION

The invention is directed to a method for mass production of modified orthodontic crowns or bands suitable for anchoring orthodontic appliances such as a Herbst appliance or a Hyrax-type expander. In the past, orthodontic bands have been produced from a relatively thin strip of metal such as stainless steel with a press such as a Waterbury-Farrel ICOP press. The Waterbury-Farrel ICOP press includes a series of cam-sequenced die presses where the workpiece is punched several times in succession, once each time it passes beneath a die. Such a press is suitable for use in the method of the invention.

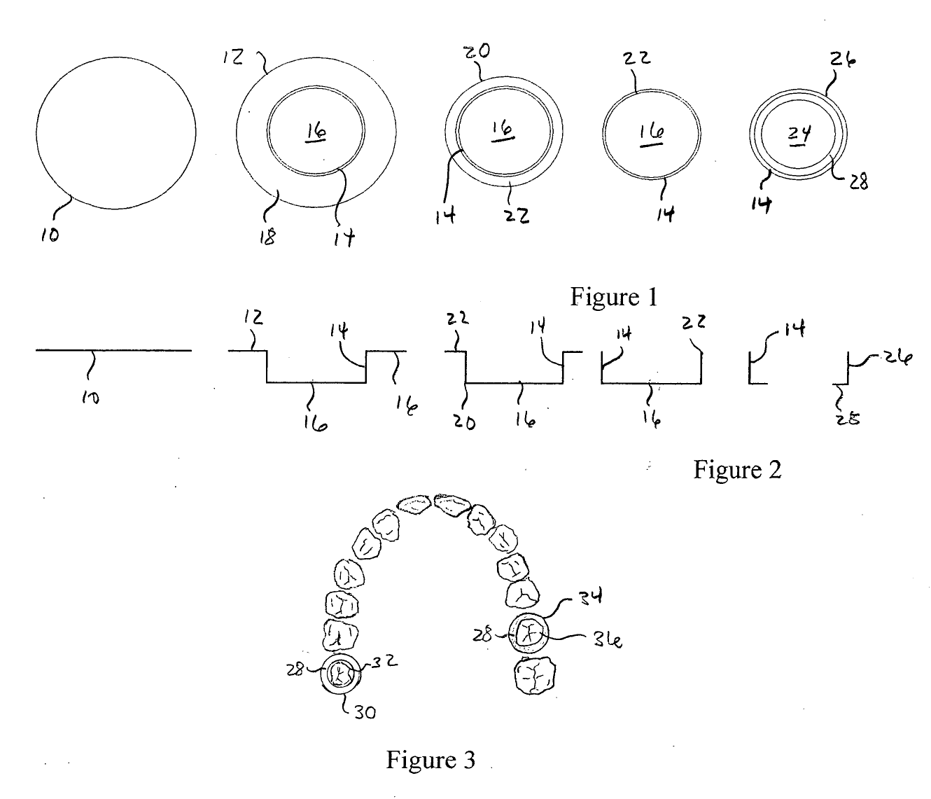

Referring to FIGS. 1 and 2, in accordance with one embodiment of the invention, the first operation in the process is die cutting a circular blank 10 from a piece of steel such as an etched stainless steel ribbon. Preferably, the thickness of the stainless ribbon used in the process is from about 0.003 to 0.015 inch. Blank 10 is typically flat at the start of the die press steps, but could have a preformed shape or profile. The stainless steel substrate may be etched as described in commonly assigned U.S. Pat. No. 5,441,409 issued Aug. 15, 1995 to Tuneberg, the disclosure of which is incorporated by reference herein, to promote adhesion of the formed crown when cemented to a tooth.

Circular blank 10 is die-pressed into a cup 12 having a substantially cylindrical sidewall 14, top wall 16 and outwardly extending annular flange 18. Flange 18 is trimmed in a further press operation to form a cup 20 having a reduced diameter flange 22. Flange 18 of cup 20 is then “wiped” or removed to form a cylindrical cup 22 with no flange. The final step in the operation is die punching a circular hole 24 in top wall 16 of cup 22 to form modified band 26.

Hole 24 is punched with a die having a diameter smaller than the inside diameter of cylindrical sidewall 14, leaving an inwardly directed annular flange 28. In the illustrated embodiment, flange 28 has a constant width and extends continuously around the inner periphery of sidewall 14. Band 26 may be produced in a variety of sizes depending upon the intended application. Typically band 26 will have a diameter of from about 0.2 to 0.6 inch and a height (depth) of from 0.1 to 0.26 inch. The width of flange 28 will typically be in the range of from 0.015 to 0.125 inch.

Referring now to FIG. 3, a band 30 produced in accordance with the invention is depicted in position on a molar 32 prior to press-fitting of the flange 28. Typically, a dental cement will be used to affix band 30 on molar 32. After band 30 has been position on molar 32, inwardly directed flange 28 is press fit into conformity with the top of molar 32. FIG. 3 illustrates a band 34 after flange 28 has been press fit to a molar 36. With the band 34 secured in position, the selected orthodontic appliance may be attached to the band using conventional techniques. Alternatively, a band 30 may be fitted to a selected tooth, removed from the tooth and attached to the orthodontic appliance, after which the appliance is installed.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is intended that the appended claims encompass any such modifications or embodiments.

1. A method for making an orthodontic band configured for mounting on a human tooth, comprising:
die pressing a metal blank into an orthodontic crown having a cylindrical sidewall, an open bottom and a round top wall; and
then die forming the crown through the top wall using a die having a diameter less than that of the cylindrical sidewall, thereby removing a round central portion of the top wall to form an inwardly directed annular flange which can be press-fit into conformity with a tooth surface when the band is mounted on the tooth.

2. The method of claim 1, wherein the flange has a width in the range of from 0.015 to 0.125 inch.

3. The method of claim 1, wherein the blank is made from stainless steel.

4. The method of claim 1, further comprising die forming the metal blank to a circular shape from a metal ribbon.

5. A method for making an orthodontic band configured for mounting on a human tooth, comprising:
feeding a piece of metal to a die press;
cutting a flat blank from the metal strip with the die press;
die forming the metal blank into cup having a sidewall, an open bottom and a top wall, the cup having a flange extending outwardly from the open bottom;
removing the outwardly extending flange from the cup; and
then die forming a hole through the top wall to form an inwardly directed annular flange.

6. The method of claim 5 wherein the step of die forming a hole through the top wall further comprises removing a circular central portion of the top wall to form the inwardly directed annular flange.

7. The method of claim 5 wherein the cup has a diameter of from 0.2 to 0.6 inch.

8. The method of claim 5 wherein the cup has a depth of from 0.1 to 0.26.

9. The method of claim 5 where in the metal is stainless steel.

10. The method of claim 5 wherein the metal piece has a thickness of from 0.003 to 0.015 inch.
